(19) United States
(12) Patent Application Publication
(10) Pub. No.: US 2020/0117755 A1
(43) Pub. Date: Apr. 16, 2020

(54) INTELLIGENT VIDEO BRIDGE FOR A CLOSED CIRCUIT TELEVISION SYSTEM

(71) Applicant: International Business Machines Corporation, Armonk, NY (US)

(72) Inventors: Laurence J. Plant, North Balwyn (AU); Stefan Harrer, Hampton (AU); Sean R. Costello, Sydney (AU); James D. Cleaver, Grose Wold (AU)

(21) Appl. No.: 16/158,418

(22) Filed: Oct. 12, 2018

(51) Int. Cl. G06F 17/30; H04N 7/18; G06N 3/063; H04L 29/08; G06K 9/62; G06K 9/00

(52) U.S. Cl. CPC G06F 17/30793; H04N 7/181; G06F 17/30979; G06K 9/00335; H04L 67/125; G06F 17/3084; G06K 9/6268; G06N 3/0635

(57) ABSTRACT

An intelligent video bridge analyzes, indexes and searches live and stored video across multiple existing disparate CCTVs. Through the intelligent video bridge, third parties such as law enforcement can concurrently access and search video feeds from a range of CCTVs, allowing the third party to more easily track persons or vehicles of interest as they move throughout the community and pass within range of different CCTV systems.

### BACKGROUND

The present invention relates to video bridges, and more specifically to an intelligent video bridge for closed circuit television (CCTV) systems.

CCTV systems include a plurality of video cameras in communication with a limited set of monitors. The video cameras transmit a signal to a specific place, on the limited set of monitors. The video cameras are commonly used for surveillance of an area, although other uses may be implemented.

CCTV systems have been deployed by different entities throughout the community over many years. Throughout this time, video analysis and cloud capabilities have continued to evolve such that legacy CCTV systems lack modern capabilities and legal agencies cannot easily access and search multiple CCTV systems concurrently.

One approach is to replace old CCTV systems with modern, updated CCTV systems in which specialized microprocessors are embedded within in the cameras. This approach requires significant capital cost and labor. Further, as technology continues to evolve, any new CCTV system is quickly out of date.

Another approach involves simply bridging all CCTV systems to a network and relaying all video from all CCTV systems to a cloud in the network. This approach would enable advanced video analysis to detect objects, people, and behavior of interest and would enable network storage to be leveraged, but would come at a high cost of network connections and bandwidth. Furthermore, many network connections only transport video streams which are static or of no interest.

Therefore, the problem then becomes how to leverage the installed base of CCTV systems and extend their capability to use advanced capabilities such as video analytics and network storage, and future capabilities, without displacing the installed base of CCTV systems and without relaying all video taken by the cameras of the CCTV system to the network or cloud.

Two CCTV systems may be disparate or non-disparate with respect to each other. For purposes of this document, CCTV systems are considered to be disparate with respect to each other when the CCTV system are controlled and maintained by different entities.

Video bridges are known. Video bridges are a communication system used in video conference to connect and collaborate multiple locations or points into a common conference. Video bridges allow for real time interaction through video and audio of the participants on the video conference.

Smart or intelligent bridges are also known. Smart bridges allow a user to monitor and control functions of multiple elements through the Internet. For example, turning a device on or off through remote control by a user.

### SUMMARY

According to one embodiment of the present invention, a method for use with a plurality of disparate closed circuit TV systems (CCTVs) is disclosed. Each CCTV includes an intelligent video bridge processor and a set of live video feed(s). The method comprising the steps of: defining a reference model data set corresponding to and descriptive of an entity; each of the CCTVs receiving a request for video feed including images of the entity containing an entity defined by the reference model; responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV; and for each instance of the entity found in a video feed, the intelligent video bridge processor sending the video feed containing the instance of the entity to the plurality of processors.

According to another embodiment of the present invention, a computer system for use with a plurality of disparate closed circuit TV systems (CCTVs) is disclosed. Each CCTV includes an intelligent video bridge processor and a set of live video feed(s). The computer system comprising the intelligent video bridge connected to each of the plurality of disparate closed circuit TV systems and a plurality of processors via a network, the intelligent video bridge comprising at least one intelligent video bridge processor, one or more memories, one or more computer readable storage media having program instructions executable by the computer to perform the program instructions. The computer program instructions comprising: defining, a reference model data set corresponding to and descriptive of an entity; each of the CCTVs via the intelligent video bridge, receiving a request for video feed including images of the entity containing an entity defined by the reference model; responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV; and for each instance of the entity found in a video feed, the intelligent video bridge processor sending the video feed containing the instance of the entity to the plurality of processors.

According to another embodiment of the present invention, a computer program product for use with a plurality of disparate closed circuit TV systems (CCTVs) is disclosed. Each CCTV includes an intelligent video bridge processor and a set of live video feed(s). The intelligent video bridge processor comprising one or more memories and one or more computer readable storage media. The computer program product comprising a computer readable storage medium having program instructions embodied therewith. The program instructions executable by the computer to perform a method comprising: defining, a reference model data set corresponding to and descriptive of an entity; each of the CCTVs via the intelligent video bridge, receiving a request for video feed including images of the entity containing an entity defined by the reference model; responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV; and for each instance of the entity found in a video feed, the intelligent video bridge processor sending the video feed containing the instance of the entity to the plurality of processors.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIG. 3 shows a schematic of the interaction between multiple CCTV systems, the video cloud, and the intelligent video bridge.

FIG. 4 shows a flow diagram of a method of receiving a request for searching and identifying an entity from a third party to search a plurality of disparate CCTV systems.

FIG. 5 shows a flow diagram of a method of concurrently accessing and searching live video feeds from a plurality of disparate CCTV systems.

FIG. 6 depicts an exemplary diagram of a possible data processing environment in which illustrative embodiments may be implemented.

FIG. 7 illustrates internal and external components of a client computer and a server computer in which illustrative embodiments may be implemented.

### DETAILED DESCRIPTION

In an embodiment of the present invention, intelligent video bridges analyze, index and search live and stored video across multiple existing disparate CCTV systems simultaneously. Through the intelligent video bridge, third parties such as law enforcement can concurrently access and search video feeds from a range of CCTV systems, allowing the third party to more easily track persons or vehicles of interest as they move throughout the community and pass within range of different CCTV systems.

An intelligent video bridge is connected to each of the monitors of the CCTV system and receives instructions on what entity is being searched for and what the entity looks like. The entity being searched for can include, but is not limited to specific objects, behaviors, and people, and their associated characteristics. The intelligent video bridge associated with each disparate CCTV system analyzes incoming video in real time and any stored video from the disparate CCTV systems to search for the entity. When the intelligent video bridge finds the entity sought, associated video of the entity and metadata are sent to a storage repository residing in a cloud, where the video and metadata can be accessed, for example by the third party.

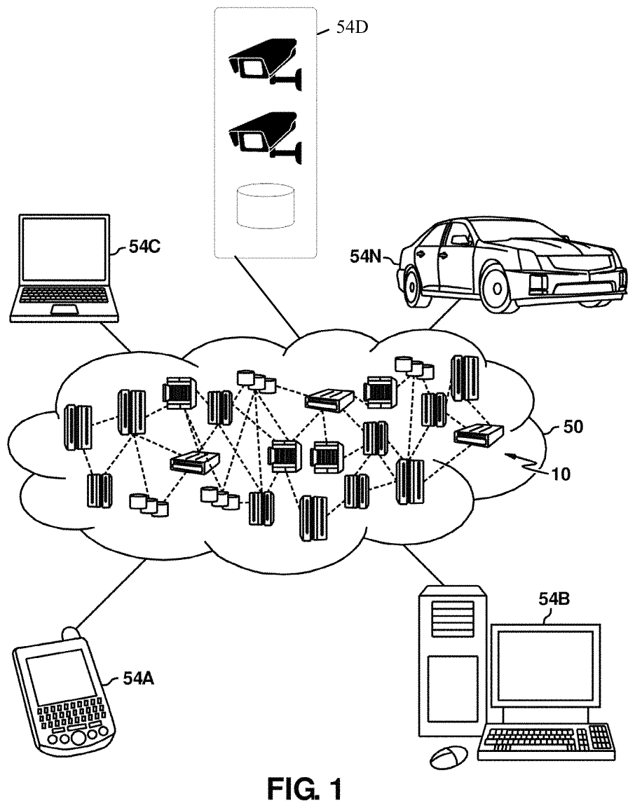

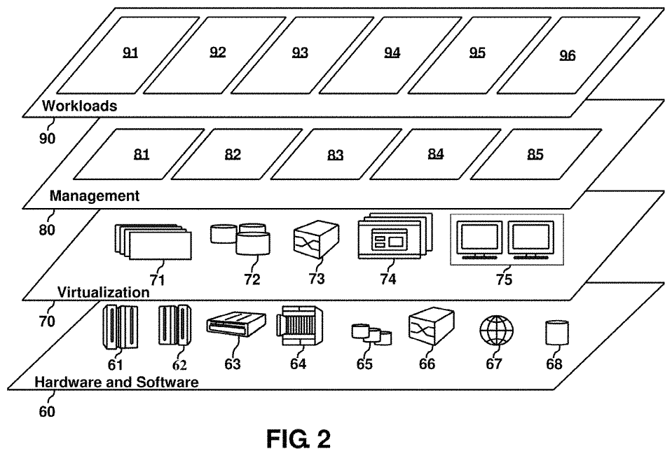

In one embodiment, the intelligent video bridge is run as a virtual machine on the cloud as shown in FIGS. 1-2.

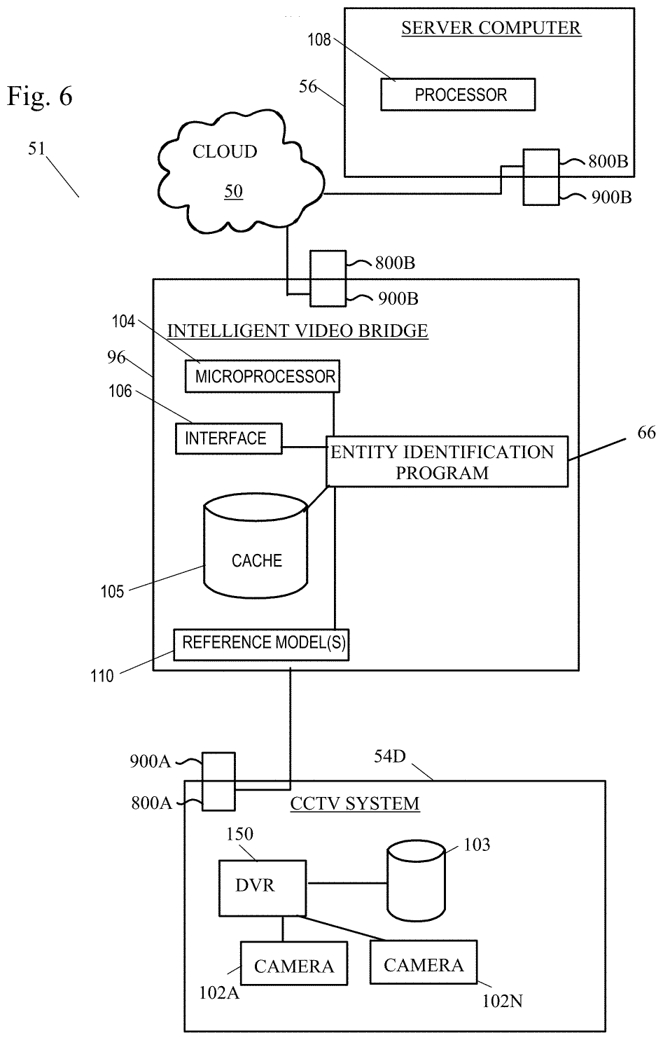

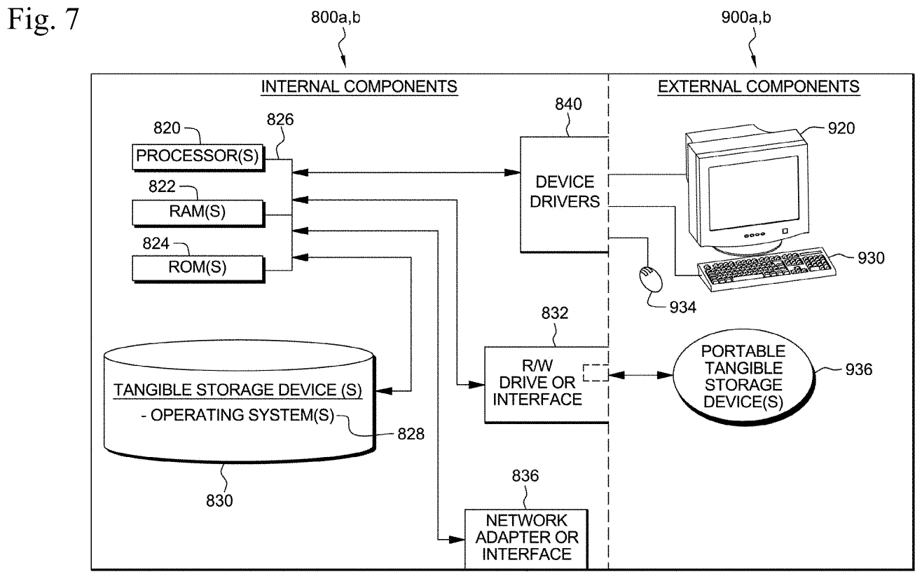

In an alternate embodiment, the intelligent video bridge can be implemented through a server computer which is connected to the CCTV systems through a network as shown in FIGS. 6-7. The intelligent video bridge is also connected to a repository with which video streams from the CCTV are sent.

In one embodiment, each CCTV system is connected to its own intelligent video bridge. In another embodiment, a plurality of disparate CCTV systems are connected to a single intelligent video bridge.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone MA, desktop computer MB, laptop computer MC, CCTV systems and their associated components MD, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and intelligent video bridging 96.

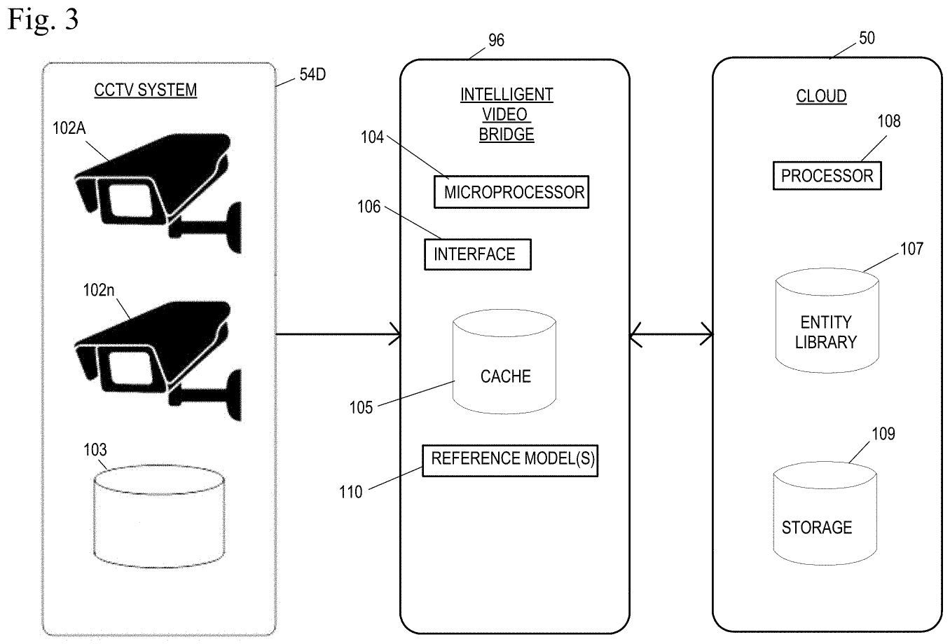

FIG. 3 shows a schematic of the interaction between a CCTV system, the intelligent video bridge and other cloud resources.

The CCTV system 54D can be an analog CCTV system or an internet protocol (IP) surveillance CCTV system each with cameras 102a-102n. The analog closed circuit TV systems have analog cameras plugged into a digital video recorder 150. The analog cameras output only a video signal. The system is limited to the number of ports on the digital video recorder. The IP surveillance CCTV systems include IP cameras that send and receive data via a computer network and the Internet.

The cameras 102a-102n of the CCTV systems 54D constantly record footage of an area. The cameras 102a-102n send the live video feed, associated metadata, and any stored video files from a repository 103 to the intelligent video bridge 96. It should be noted that in the case of analog CCTV systems, the digital video recorder or another device can send the video signal outputted from the analog cameras to the intelligent video recorder 96. In the case of the IP surveillance CCTV systems, the IP cameras can send the video signal/feed directly to the intelligent video bridge 96.

It should be noted that while a single CCTV system 54D is shown as being connected to a single intelligent video bridge 96, a single intelligent video bridge can be connected to a plurality of disparate CCTV systems. While one CCTV system is shown, a plurality of disparate CCTV systems MD are connected to the cloud or network 50. The disparate CCTV systems 54D can be a mix of analog CCTV systems and IP surveillance CCTV systems.

The intelligent video bridge 96 has a microprocessor 104, preferably a neuromorphic microprocessor for video image recognition, a cache or repository 105 for temporarily storing video and metadata, and at least one interface 106. The interface(s) 106 receive(s) live video signals and associated metadata from a plurality of disparate CCTV systems 54D, accesse(s) CCTV video files stored in a repository 103 of the CCTV system 54D, and can send and receive information, live video signals, alerts and other information from the cloud 50.

The intelligent video bridge 96 acts as a bridge to connect the CCTV system(s) 54D to the cloud 50. The intelligent video bridge 96 can receive external search requests or data to use during analysis of the video signals received from the CCTV systems. The external search requests may be from different users, such as the provider of security services to an enterprise or law enforcement.

While only one intelligent video bridge 96 is shown, additional video bridges are present and connected to the cloud or network 50.

The intelligent video bridge 96 uses video analysis through the maintenance of reference models to automatically detect and index objects of interest, persons of interest, and behavior of interest at the point of video capture in real time. The reference models 110 include information that aids the intelligent video bridge to learn, identify through descriptions, objects, people and behavior. The reference models 110 can be updated and maintained through the cloud 50. Any video feed or files including object(s) of interest, persons of interest, or behavior of interest with associated metadata is sent to the cloud 50. The metadata can include, but is not limited to time the video was taken, location the video was taken and other information associated with object, person or behavior identification. The camera(s) 102A-102N and/or CCTV systems 96 may already have embedded video or image analysis capability in which the findings of the embedded analytics is stored in the CCTV system 54D and accessed by the intelligent video bridge 96.

If the intelligent video bridge 96 cannot confidently identify an object, person or behavior, the video feed or files can be relayed to the cloud 50 for further inspection, thereby enabling a hybrid model of analysis. If the intelligent video bridge is unable to search the video feed within a designated time frame, for example for urgent requests, or if the intelligent video bridge does not have capacity to process the request at all the intelligent video bridge can pass the video to an additional platform for analysis. For example, the intelligent video bridge 96 can pass video to a central cloud platform, such as cloud 50 as shown in FIGS. 1 and 3 or peer intelligent video bridges accessible over the network. In this way the analytics can be shared between different intelligent video bridges and other available, trusted platforms.

Video feed and video files that do not include objects of interest, persons of interest, or behavior of interest are not conveyed from the intelligent video bridge to the cloud, decreasing storage and bandwidth required for surveillance of an area. For example, a video of a closed garage door in which no objects are present, people are present or behavior is presented by a person would not be sent to the cloud 50.

Some advantages of using the intelligent video bridge 96 include the incorporation of video analysis capability with automatic detection and indexing of objects, persons of interest and behavior of interest at the point of video capture for legacy CCTV systems which do not have any such capabilities. Furthermore, the intelligent video bridge 96 optimizes the computer network by decreasing bandwidth and storage by only passing videos with of identification of an entity of interest or videos with an object, person or behavior of interest from the captured video signal of the CCTV system 54D to the cloud 50. The intelligent video bridge 96 additionally connects disparate CCTV systems 54D to a single external system, such as the cloud 50 or server computer 56.

The cloud 50 has a library of reference models 107, processor(s) 108, and storage 109.

The library of reference models 107 include entities for which the intelligent video bridge 96 can search.

The processor(s) 108 convey(s) what entities are to be sought to each intelligent video bridge 96, use(s) machine learning to learn new entities and store(s) the new entities in the library 107, relay(s) updated reference models and associated metadata to the intelligent video bridge 96, including the new learned entities, advance video analysis, and can detect anomalies across a set of distributed intelligent video bridges. An example of a detected anomaly is the processor detecting two different vehicles with the same license plate from different video feeds (e.g. different locations) from different intelligent bridges after a request for the license plate was sent out. Speeding for example, could be detected by using metadata associated with the location of the video feed and/or the cameras and a geospatial system with data associated with speed limits during specific time periods during the day.

The storage 109 stores video feeds received from intelligent video bridges 96.

In an alternate embodiment, the intelligent video bridge can be implemented through a server computer as shown in FIGS. 6-7.

FIG. 6 is an exemplary diagram of a possible data processing environment provided in which illustrative embodiments may be implemented. It should be appreciated that FIG. 6 is only exemplary and is not intended to assert or imply any limitation with regard to the environments in which different embodiments may be implemented. Many modifications to the depicted environments may be made.

Referring to FIG. 6, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, CCTV system 54D through an intelligent video bridge is connected to a server computer 56 through a network 50. In other exemplary embodiments, network data processing system 51 may include additional intelligent video bridges or device computers, storage devices or repositories, server computers, and other devices not shown.

The intelligent video bridge 96 has a microprocessor 104, preferably a neuromorphic microprocessor for video image recognition, a cache or repository 105 for temporarily storing video and metadata, and at least one interface 106. The interface(s) 106 receive(s) live video signals and associated metadata from the CCTV system(s) MD, accesse(s) CCTV video files stored in a repository 103 of the CCTV system(s) MD, and can send and receive information, live video signals, alerts and other information from the server computer 56 via the network or cloud 50 through the entity identification program 66.

The intelligent video bridge 96 acts as a bridge to connect the CCTV system(s) 54D to the network or cloud 50 and preferably includes the components shown in FIG. 3. The intelligent video bridge 96 can receive external search requests or data to use during analysis of the video signals received from the CCTV system(s), for example from the server computer 56. The external search requests may be from different users, such as the provider of security services to an enterprise or law enforcement. The intelligent video bridge 96 preferably includes an entity identification program 66. While not shown, it may be desirable to have the entity identification program 66 be present on the server computer 56. The intelligent video bridge 96 includes a set of internal components 800a and a set of external components 900a, further illustrated in FIG. 7.

Server computer 56 includes a set of internal components 800b and a set of external components 900b illustrated in FIG. 7. In the depicted example, server computer 56 provides information, such as boot files, operating system images, and applications to the intelligent video bridge 96. Server computer 56 can compute the information locally or extract the information from other computers on network 50. The server computer 56 may contain the entity identification program 66. Additionally, requests for specific entity searches can be received and routed to the intelligent video bridge 96 through the entity identification program 66. The server computer 56 can include components such as a processor 180, an entity library 107 and storage 109 as discussed relative to FIG. 3.

Program code and programs such as the entity identification program 66 may be stored on at least one of one or more computer-readable tangible storage devices 830 shown in FIG. 7, on at least one of one or more portable computer-readable tangible storage devices 936 as shown in FIG. 7, or may be downloaded to the intelligent video bridge 96 or server computer 56, for use. For example, program code and programs such as entity identification program 66 may be stored on at least one of one or more storage devices 830 on server computer 56 and downloaded to the intelligent video bridge 96 over network 50 for use. Alternatively, server computer 56 can be a web server, and the program code, and programs such as entity identification program 66 may be stored on at least one of the one or more storage devices 830 on server computer 56 and accessed intelligent video bridge 96. In other exemplary embodiments, the program code, and programs such as entity identification program 66 may be stored on at least one of one or more computer-readable storage devices 830 on intelligent video bridge 96 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 6 is intended as an example, and not as an architectural limitation, for the different illustrative embodiments.

In one embodiment, the intelligent video bridge 96 is in the same premises as the CCTV system 54D. In this embodiment, the intelligent video bridge 96 connects directly to the CCTV system 54D and analyzes the metadata associated with stored and streaming video stored within the digital video recorder (DVR) 150, stored video in the DVR 150 and video streaming from the cameras 102A-102N to the DVR 150. The metadata preferably includes a record of what footage as collected from what camera and when. With the intelligent video bridge 96 in the same physical location as the CCTV system 54D, analysis of the CCTV video footage can take place at the edge of the network, reducing the network bandwidth requirements, since only relevant video containing an entity is sent to the server computer or a cloud based network.

In an alternate embodiment, the intelligent video bridge 96 could be located off-premise from the CCTV system 54D and remotely connects to the CCTV system 96. In this embodiment, the intelligent video bridge 96 receives or initiates searching and analysis of video footage when a request for a specific entity is received. A single intelligent video bridge 96 is preferably associated with each CCTV system MD. This embodiment is advantageous when the CCTV system MD is in a physical environment which is not easily accessible.

It should be noted that in another embodiment, the CCTV systems 54D can also be deployed outside a premises, for example on a roadway where a camera is attached to a pole or gantry.

In yet another embodiment, a single intelligent video bridge 96 is connected to a plurality of disparate CCTV systems 54D.

FIG. 7 illustrates internal and external components of an intelligent video bridge 96 and server computer 56 in which illustrative embodiments may be implemented. In FIG. 7, an intelligent video bridge 96 and a server computer 56 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and entity identification program 66 are stored on one or more of the computer-readable tangible storage devices 830 for execution by one or more of the processors 820 via one or more of the RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Entity identification program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Entity identification program 66 can be downloaded to the intelligent video bridge 96 and server computer 56 from an external computer via a network (for example, the Internet, a local area network or other, wide area network) and network adapter or interface 836. From the network adapter or interface 836, entity identification program 66 is loaded into hard drive 830. Entity identification program 66 can be downloaded to the server computer 56 from an external computer via a network (for example, the Internet, a local area network or other, wide area network) and network adapter or interface 836. From the network adapter or interface 836, entity identification program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Entity identification program 66 can be written in various programming languages including low-level, high-level, object-oriented or non object-oriented languages. Alternatively, the functions of an entity identification program 66 can be implemented in whole or in part by computer circuits and other hardware (not shown).

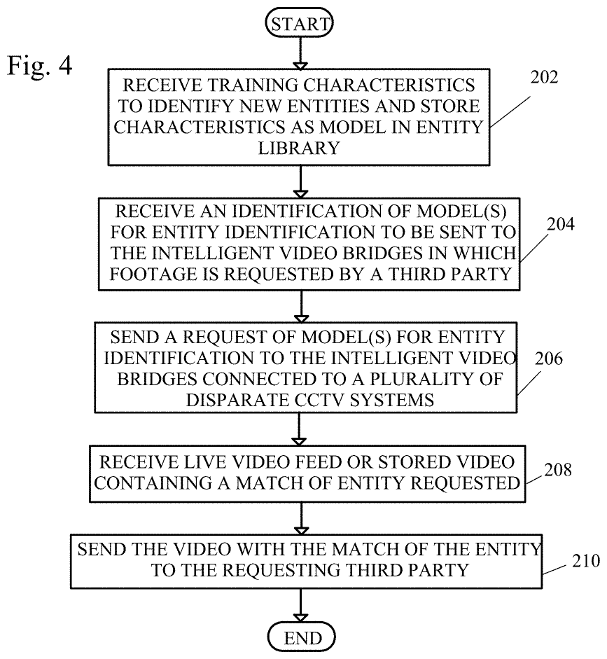

FIG. 4 shows a flow diagram of a method of receiving a request for searching and identifying an entity from a third party to search a plurality of disparate CCTV systems.

In a first step, processors of the cloud 50 or server computer 56 receives training on characteristics to identify new entities and stores the characteristics in the entity library as a model for entity identification (step 202), for example through a machine learning system. It should be noted that this step would not take place every time the method is executed, but as new entities are to be identified. The method would start with step 204. Sample data is preferably used to train the processors to recognize specific entities or determine an inference model using pattern recognition to recognize specific entities such as a license plate and associated numbers and letters. This reference or inference model including reference model data is exported and distributed to the intelligent video bridge(s) 96. The training associated with the reference model can include being able to determine a match to the reference model with a specific confidence level. The amount of sample data used for training for a reference model increases as the confidence level increases. As requirements associated with a reference model are determined, a reference model is only deployed for use with the intelligent video bridge 96 when the intelligent video bridge 96 can locate a match to a required confidence level.

The processor of the cloud 50 or the server computer 56 then sends a request for video feed containing an entity defined by the reference model(s) to the intelligent video bridges connected to the CCTV system (step 206).

The cloud 50 or server computer 56 receives any live video feed or stored video containing an instance of a match of entity to the chosen reference model requested (step 208) and the cloud sends a notification and/or video containing only the instance of the match of the entity to the requesting third party (step 210) and the method ends.

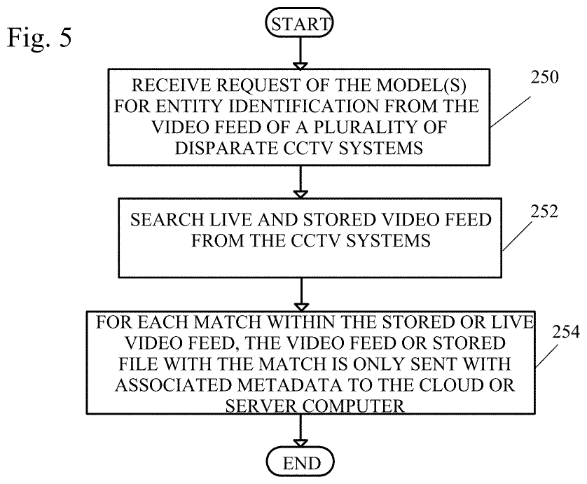

FIG. 5 shows a flow diagram of a method of concurrently accessing and searching live video feeds from a plurality of disparate CCTV systems.

In a first step, each intelligent video bridge receives the request for video feed containing an entity defined by the reference model(s) for entity identification from the video feed of each disparate CCTV system (step 250). The request preferably includes images of the entity containing an entity defined by the reference model.

Each intelligent video bridge 96 concurrently accesses and searches live and stored video feed from the CCTV system 54D in which it is connected for the entity (step 252). For each intelligent video bridge 96 and its associated CCTV system(s) 54D, data is compared to the reference model stored in each intelligent video bridge 96 simultaneously and in real time. As described above, the reference model provides data required for the intelligent video bridge to recognize specific entities.

For each instance of the entity found or entity match within the stored or live video feed, each intelligent video bridge 96 sends only the video with the instance of the entity, based on the reference model, and associated metadata to the cloud 50 or server computer 56 (step 254) and the method ends. Each match of an entity, a confidence level can additional be determined. Furthermore, a match can be further defined by a confidence level specifically requested with the request received by the intelligent video bridge(s) 96.

If the intelligent video bridge 96 is unable to search the video feed within a designated time frame, for example for urgent requests, or if the intelligent video bridge 96 does not have capacity to process the request at all the intelligent video bridge 96 can pass the video to an additional platform for analysis. For example, the intelligent video bridge 96 can pass video to a central cloud platform, such as cloud 50 as shown in FIG. 3 or peer intelligent video bridges accessible over the network. In this way the analytics can be shared between different intelligent video bridges and other available, trusted platforms.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for use with a plurality of disparate closed circuit TV systems (CCTVs), with each CCTV including an intelligent video bridge processor and a set of live video feed(s), the method comprising the steps of:
defining a reference model data set corresponding to and descriptive of an entity;
each of the CCTVs receiving a request for video feed including images of the entity containing an entity defined by the reference model;
responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV;
responsive to a low confidence of positive identification of the entity in the video images, sending the video images to a platform to confirm identification of the entity in the video images; and
for each instance of the entity confirmed in the video images of a video feed, the intelligent video bridge processor sending the video feed containing the instance of the entity to the plurality of processors.

2. The method of claim 1, wherein the intelligent video bridge processor further sends metadata associated with the video feed containing the instance of the entity.

3. The method of claim 1, wherein the reference models comprises characteristics to identify an object of interest, person of interest and behavior of interest defining the entity.

4. The method of claim 1, wherein the reference models are updated by the plurality of processors to add additional entities and associated characteristics which can be used to identify the entity.

5. The method of claim 1, wherein the disparate CCTVs are analog closed circuit TV systems comprising a plurality of analog cameras which output only a video signal.

6. The method of claim 1, wherein the disparate CCTVs are internet protocol surveillance closed circuit TV system comprising a plurality of internet protocol cameras that send and receive data via a network.

7. The method of claim 1, wherein the disparate CCTVs are a combination of analog closed circuit TV systems comprising a plurality of analog cameras which output only a video signal and internet protocol surveillance closed circuit TV system comprising a plurality of internet protocol cameras that send and receive data via a network.

8. (canceled)

9. A computer system for use with a plurality of disparate closed circuit TV systems (CCTVs), with each CCTV including an intelligent video bridge processor and a set of live video feed(s), the computer system comprising the intelligent video bridge connected to each of the plurality of disparate closed circuit TV systems and a plurality of processors via a network, the intelligent video bridge comprising at least one intelligent video bridge processor, one or more memories, one or more computer readable storage media having program instructions executable by the computer to perform the program instructions comprising:
defining, a reference model data set corresponding to and descriptive of an entity;
each of the CCTVs via the intelligent video bridge, receiving a request for video feed including images of the entity containing an entity defined by the reference model;
responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV;
responsive to a low confidence of positive identification of the entity in the video images, sending the video images to a platform to confirm identification of the entity in the video images; and
for each instance of the entity confirmed in the video images of a video feed, the intelligent video bridge processor sending the video feed containing the instance of the entity to the plurality of processors.

10. The computer system of claim 9, wherein the intelligent video bridge processor further sends metadata associated with the video feed containing the instance of the entity.

11. The computer system of claim 9, wherein the reference models comprises characteristics to identify an object of interest, person of interest and behavior of interest defining the entity.

12. The computer system of claim 9, wherein the reference models are updated by the plurality of processors to add additional entities and associated characteristics which can be used to identify the entity.

13. The computer system of claim 9, wherein the disparate CCTVs are analog closed circuit TV systems comprising a plurality of analog cameras which output only a video signal.

14. The computer system of claim 9, wherein the disparate CCTVs are internet protocol surveillance closed circuit TV system comprising a plurality of internet protocol cameras that send and receive data via a network.

15. The computer system of claim 9, wherein the disparate CCTVs are a combination of analog closed circuit TV systems comprising a plurality of analog cameras which output only a video signal and internet protocol surveillance closed circuit TV system comprising a plurality of internet protocol cameras that send and receive data via a network.

16. (canceled)

17. A computer program product for use with a plurality of disparate closed circuit TV systems (CCTVs), with each CCTV including an intelligent video bridge processor and a set of live video feed(s), the intelligent video bridge processor comprising one or more memories and one or more computer readable storage media, the computer program product comprising a computer readable storage medium having program instructions embodied therewith, the program instructions executable by the computer to perform a method comprising:
defining, a reference model data set corresponding to and descriptive of an entity;
each of the CCTVs via the intelligent video bridge, receiving a request for video feed including images of the entity containing an entity defined by the reference model;
responsive to the requests, each of the intelligent video bridge processors concurrently searching for video images of the entity using the reference model, with the searching including searching video images from the set of live video feed(s) of the respectively associated CCTV and searching video images from the set of stored video feed(s) of the respectively associated CCTV;
responsive to a low confidence of positive identification of the entity in the video images, sending the video images to a platform to confirm identification of the entity in the video images; and
for each instance of the entity confirmed in the video images of a video feed, the intelligent video bridge processor sending the video feed containing the instance of the entity to the plurality of processors.

18. The computer program product of claim 17, wherein the reference models comprises characteristics to identify an object of interest, person of interest and behavior of interest defining the entity.

19. The computer program product of claim 17, wherein the disparate CCTVs are analog closed circuit TV systems comprising a plurality of analog cameras which output only a video signal.

20. The computer program product of claim 17, wherein the disparate CCTVs are a combination of analog closed circuit TV systems comprising a plurality of analog cameras which output only a video signal and internet protocol surveillance closed circuit TV system comprising a plurality of internet protocol cameras that send and receive data via a network.

21. The method of claim 1 wherein the platform is provided as a service in a cloud environment.
